(19) United States
(12) Patent Application Publication
(10) Pub. No.: US 2008/0109258 A1
(43) Pub. Date: May 8, 2008

(54) PROCESS TO ADMINISTER, STORE, AND DISSEMINATE INFORMATION VIA A WEB-ENABLED INTERFACE AND DATABASE

(76) Inventors: Ira Kirschenbaum, White Plains, NY (US); Scott Zeitzer, New Orleans, LA (US)

Correspondence Address: LACKENBACH SIEGEL, LLP, LACKENBACH SIEGEL BUILDING, 1 CHASE ROAD, SCARSDALE, NY, 10583, US

(21) Appl. No.: 11/556,687

(22) Filed: Nov. 4, 2006

(51) Int. Cl. G06Q 50/00

(52) U.S. Cl. 705/3

(57) ABSTRACT

A process to securely administer, store, and disseminate independent medical examination (IME) reports via a web-enabled interface includes a system for auditing a generation process of completed IME reports and the end report itself. A sequenced delivery system enables scheduling of delivery of IME reports and related information according to a programmable schedule using a variety of delivery modalities for compliance with contractual, regulatory, and legal restrictions. A plurality of qualified panelists schedule and purse claimant requests for generation of an IME along a guided web-enabled system and an accounting module enables invoice and financial management of the same.

### CROSS REFERENCE TO RELATED APPLICATION

This application claims priority from U.S. Prov. App. Ser. No. 60/733,863 filed Nov. 3, 2005, the entire contents of which are herein incorporated by reference.

### BACKGROUND OF THE INVENTION

1. Field of the Invention

The present invention relates to a system for generating an independent medical examination (IME) via a web-enabled interface. More specifically, the present invention relates to a system, method, and apparatus for enabling an independent medical examination (IME) report upon request, for providing a quality review, and for enabling a tracking and accounting of the process.

2. Description of the Related Art

The related art involves the generation of printed independent medical examination (IME's) reports that necessary to the proper function of a multitude of every day circumstances, particularly where there are health claims, injury resolutions or workmen's compensation or automobile liability involved.

These IMEs are presently crafted either upon the request of the injured party or upon the request of the insurance carrier or perhaps a litigant during a litigation process.

Unfortunately, heretofore no cohesive or web based system had been involved, no international review process involving worldwide medical practitioners had been involved, no accounting system had been involved for billing of the same period, and there was no audit and verification system for enabling verifiable audits to minimize accusations IME reports.

Conventional IME report systems existed within medical offices, often involving dictated and written systems without back up and with mere paper integration of documents.

Similarly what had not been appreciated by the prior art is the need for timed and scheduled delivery of generated IMEs according to court orders, workers compensation regulations, federal requirements or contractual requirements. As a result, related art systems often provided IMEs to the incorrect locations, at incorrect times, and in incorrect sequences.

Further, the related art has noted detrimentally that accusations of record tampering and record altering have been raised in many areas of the health care practice and the litigation and contract practices. Similarly, there has been no accurate chain for delivery or record generation throughout the related art. In the past these bits of information had been manually compiled or processed in parts though a closed networked computer system within, for example, a law firm or a doctor's office or within an insurance carrier. As a result, the process had not functioned suitably. For example, the doctors producing reports had failed to produce those reports in a timely manner and the doctors who produced those reports (who are typically outside the company) were not compensated in a timely or properly for their work product.

Accordingly, there is a need for an automated web-enabled system, method, or apparatus to administer, store, and disseminate an independent medical examination (IME) report, and enable an editable and accountable process of the same.

### OBJECTS AND SUMMARY OF THE INVENTION

An object of the present invention is to provide a process, system, and method that enables at least one of the goals noted above.

Another object of the present invention is to provide an automated web-enabled system, method, or apparatus to administer, store, and disseminate an independent medical examination (IME) report.

The present invention relates to a process, system, and method to securely administer, store, and disseminate independent medical examination (IME) reports via a web-enabled interface includes a system for auditing a generation process of completed IME reports and the end report itself. A sequenced delivery system enables scheduling of delivery of IME reports and related information according to a programmable schedule using a variety of delivery modalities for compliance with contractual, regulatory, and legal restrictions. A plurality of qualified panelists schedule and purse claimant requests for generation of an IME along a guided web-enabled system and an accounting module enables invoice and financial management of the same.

According to an embodiment of the present invention there is provided a method, for managing an invoice generation system for use during an independent medical examination (IME), the method comprising the steps of: providing a secure-access electronic computer system for managing the generation of an independent medical examination report product and the invoice, enabling at least one qualified examination panelist to access the secure-access electronic computer system, providing at least one prepared independent medical examination agreement for acceptance by the qualified examination panelist, initiating a first electronic panelist invoice check point upon an acceptance of the independent medical examination agreement thereby engaging the panelist to conduct the independent medical examination report and opening the invoice generation system for tracking the independent medical examination, initiating a second electronic panelist invoice check point in the invoice tracking system upon a documentation by the panelist as to whether or not a patient appeared at a scheduled time for the examination and completed of such examination, initiating a third electronic panelist invoice check point in the invoice tracking system upon a completion of an initial data entry of a result of the examination, and initiating a fourth electronic panelist invoice check point in the invoice tracking system upon a final authorization by the panelist of a completed the independent medical examination report product incorporating the initial data entry, whereby the method enables a generation of an invoice for the panelist and a payment of the panelist.

According to an embodiment of the present invention there is provided a method, wherein the step of initiating the second electronic panelist invoice check point further includes the step of: determining at least a first deduction of a fee paid to the panelist upon at least a first timed delay of the panelist to complete the step of initiating a

According to an embodiment of the present invention there is provided a method, wherein: the step of providing a secure-access electronic computer system further comprises the step of: providing an internet access to the electronic computer system, whereby the method enables a convenient use.

According to another aspect of the present invention, there is provided a system, for generating an independent medical examination (IME) report product, the system comprising: electronic means for generating a request from a first party for an independent medical examination of a claimant by at least one panelist from a plurality of available panelists, means for selecting and engaging the at least one panelist to conduct the independent medical examination, invoice tracking means for tracking a scheduling and an examination activity of the at least one panelist relative to a process schedule of the independent medical examination, electronic means for recording a completed independent medical examination report product in a secure authorized user accessible computer system upon a completion of the independent medical examination report product, and means for scheduling a sequenced delivery of at least one designated element in the independent medical examination report to at least one of a plurality of notification team members along an authorized pathway, whereby the system enables a secure recordation and delivery of an independent medical examination report in a reliable and effective manner.

According to another aspect of the present invention, there is provided a system, wherein: the first party is at least one of a group comprising, a claimant, an insured individual, an insurance agent, a legal party, a panelist, and a notification team member.

According to another aspect of the present invention, there is provided a system, wherein: the means for scheduling a sequenced delivery of at least one designated element further comprises: means for recording both delivery mode preference and a delivery schedule requirement of the at least one notification team member, and means for transmitting the independent medical examination report by the delivery mode preference at the delivery schedule requirement to the at least one notification team member, whereby the system enables a reliable delivery of the report at a reduced report loss rate.

According to another aspect of the present invention, there is provided a system, further comprising: computer tracking means for receiving and recording the request from the first party for the independent medical examination of the claimant, computer management and data base means for enabling the system to be securely accessed via the world-wide web and for information retained thereon to be accessible by an authorized user.

According to another aspect of the present invention, there is provided a system, further comprising: independent review means in the electronic means for recording a completed independent medical examination report, and the independent review means comprising: at least one means for generating an independent review of the completed independent medical examination by least one additional panelist from the plurality of available panelists that is different from the one panelist, whereby the system enables the independent review as a quality control measure.

According to another aspect of the present invention, there is provided a system, for enabling an auditable secure independent medical examination (IME) report, the system comprising: an electronic system for originating and tracking a development of the independent medical examination (IME) report, the electronic system comprising: secure electronic database means for enabling a secure entry by a plurality of authorized users of a plurality of tracking steps employed by the system for recording and storing execution data of respective the plurality of tracking steps and entry data of respective the plurality of users, electronic means for generating a request from a first party for an independent medical examination of a claimant by at least one panelist from a plurality of available panelists, the electronic means including means for securely entering a record of the generation of the request in the secure electronic database means, means for selecting and engaging the at least one panelist to conduct the independent medical examination, the means for selecting and engaging including means for securely entering a record of the selecting and engaging in the secure electronic database means, electronic means for recording a completed independent medical examination report product in the secure authorized user accessible database upon a completion of the independent medical examination report product, and report means for generating an auditable report of each entry of respective the records, each the authorized user access of the respective the records, and the independent medical examination (IME) report in the secure database, whereby an external review of the system and the database enables a determination of changes to the database via an audit report.

According to another aspect of the present invention, there is provided a system, further comprising: invoice tracking means for tracking a scheduling and an examination activity of the at least one panelist relative to a process schedule of the independent medical examination, and the invoice tracking means for tracking including means for securely entering a record of the scheduling and the examination activity in the secure electronic database means, thereby enabling an auditable record of the examination activity.

According to another aspect of the present invention, there is provided a system, further comprising: means for scheduling a sequenced delivery of at least one designated element in the independent medical examination report to at least one of a plurality of notification team members along an authorized delivery pathway, whereby the system enables a secure recordation and delivery of an independent medical examination report in a reliable and effective manner, and the means for scheduling a sequenced delivery including means for securely entering a record of the sequenced delivery in the secured electronic database, thereby enabling an auditable record of the sequenced delivery.

According to another aspect of the present invention, there is provided a system, for enabling a timed distribution of an independent medical examination (IME) report, the system comprising: means for generating a secure access database for receiving and storing the generated independent medical examination (IME) report, database means for receiving and storing an inputted sequenced delivery preference of at least one designated element in the independent medical examination (IME) report to at least one of a plurality of notification team members along at least one of a plurality of authorized delivery pathway, means for scheduling a delivery of the designated element in the independent medical examination (IME) report according to the inputted preferred sequenced delivery, and means for delivering the designated element via the authorized delivery pathway, whereby the system enables the timed distribution of the at least one element to the at least one notification team member in a reliable and predetermined manner.

According to another aspect of the present invention, there is provided a system, for enabling a timed distribution of an independent medical examination (IME) report, the system further comprising: a plurality of inputted sequenced delivery preferences of respective the designated elements matched with a respective plurality of authorized delivery pathways.

According to another aspect of the present invention, there is provided a system, for enabling a timed distribution of an independent medical examination (IME) report, wherein: at least two of the respective inputted sequenced delivery preferences being on differing days, and at least two of the respect authorized delivery pathways being different, whereby the means for delivering enables the timed distribution in a reliable manner despite preference and pathway differences.

According to another aspect of the present invention, there is provided a management method managing the generation and transmission of an independent medical examination with a generating system, the method comprising the steps of: initiating an authorized entry of the generation system via a web-enabled interface, entering a plurality of information effective to complete a web-enabled request initiation form for generating a request of the independent medical examination by a claimant, generating a request summary report for requesting the independent medical examination, automatically notifying the generating system upon a user-completion of the web-enabled request initiation form, employing a book marking system for preparing a medical request summary and for posting of the same on the generating system, arranging for an appointment of the claimant with at least one of a plurality of panel members and for posting the appointment on the system, conducting, by the at least one panel member, of an independent medical examination, returning a completed independent medical examination report to selected ones of the panel members for a quality assurance review of the same, and uploading a quality-assurance-completed independent medical examination report to the system for distribution of the same.

The above, and other objects, features and advantages of the present invention will become apparent from the following description read in conduction with the accompanying drawings, in which like reference numerals designate the same elements.

### BRIEF DESCRIPTION OF THE DRAWINGS

FIG. 1 is a schematic of one embodiment of the independent medical examination (IME) system as proposed.

FIG. 2 is an image view of a web-enabled log-in interface for the proposed system.

FIG. 3 is image of an exemplary report summary for a completed IME report.

FIG. 4A is a partial image of a web-enabled detailed information intake form for inputting client, legal, and transmission information, as shown.

FIG. 4B is a continued partial image of the information intake form shown in FIG. 4A.

FIG. 5 is an image of a case information dialog box regarding a scheduled appointment.

FIG. 6A is a partial image of a complete case information dialog box introduced in FIG. 5.

FIG. 6B is a continued partial image of a complete case information dialog box as introduced in FIG. 6A.

FIG. 7 is an image of a system search and sorting window according to the present invention.

FIG. 8 is an image of an advanced search feature within the presently proposed invention.

FIG. 9 is a detailed image of the results of an advanced search according to the user of entry points in FIGS. 7, and 8.

FIG. 10 is an image of a system search according to an “any” or an “all” function allowing broad-brush content searching.

FIG. 11 is an image of respective search menus for detailed search contents according to the present invention.

FIG. 12 is an image of a system search feature enabling an alternative “is” or an alternative “is not”.

FIG. 13 is an image of a system search feature enabling a search by type of search initiation.

### DETAILED DESCRIPTION OF THE PREFERRED EMBODIMENTS

Reference will now be made in detail to several embodiments of the invention that are operatively discussed and illustrated in the accompanying drawings.

For convenience, the acronym IME as used herein represents broadly the phrase Independent Medical Examination, and the acronym IMER as used herein represents broadly the phrase Independent Medical Examination Report and may refer to a report itself, an element within the report, an element that supports the report, or combinations of the same. As will be used hereafter the phrase “Administrator” is a representative from the administrator performing administrative functions. A “Panel” while it may be broadly interpreted is specifically used in the examples as a health care provider who performs functions related to the product (the proposed system and method) such as an independent medical examination or review. A “Client” is an individual or group that requests a product (an IME review). Required parties are entities that by contract or law or agreement need to receive a copy of a product. A claimant is the injured party that initiates a claim for review. A Nurse legal consultant is a specially trained medical representative (a registered nurse) trained in medicolegal aspects of review. A claims representative is a person representing a client responsible for a specific claim.

Before detailing an exemplary flow process for a preferred embodiment of the present system an initial discussion is provided. The present invention provides numerous advantages over the related art particularly involving the aspects of timing meaning the ability to provide reports at select times in select modes for select reasons. For example, the proposed management structure allows the submission of workmen's compensation reports at a cohesive date (as required by the workmen's compensation laws throughout the United States requiring that each party receive a report at the same time). However, the present system allows those reports to be submitted in various modes by mail, facsimile, e-mail all at the same time or at designated times so that timing matters; for example the mailing of the report to a first party six days before an e-mail goes out to a second party may be successfully managed to enable simultaneous or scheduled receipt of respective reports.

Similarly other laws or contract requirements may require for example that an insurance carrier receive or report on day six from a start date and the attorney for the opposing side receive the report on day eight and the injured party receive a report on day nine. In this way, timing has been an essential detriment lacking from the prior art and present system being web-based and computer managed allows for the same.

Therefore, selected aspects of the proposed improvements include speed and quality for reduced loss records, reduced failure of timing failures based on law or contract requirements and more particularly address the previously unsolved problem of audit or altered records.

Broadly, within the present system when a client requests such a report, the request is sent to a physician who is being asked at a suitable location, at a suitable time and suitable level of specialty to conduct the IME and upon completion of that electronic report, submits that report to a suitably preloaded series of locations and billing and finance is been provided to the doctor.

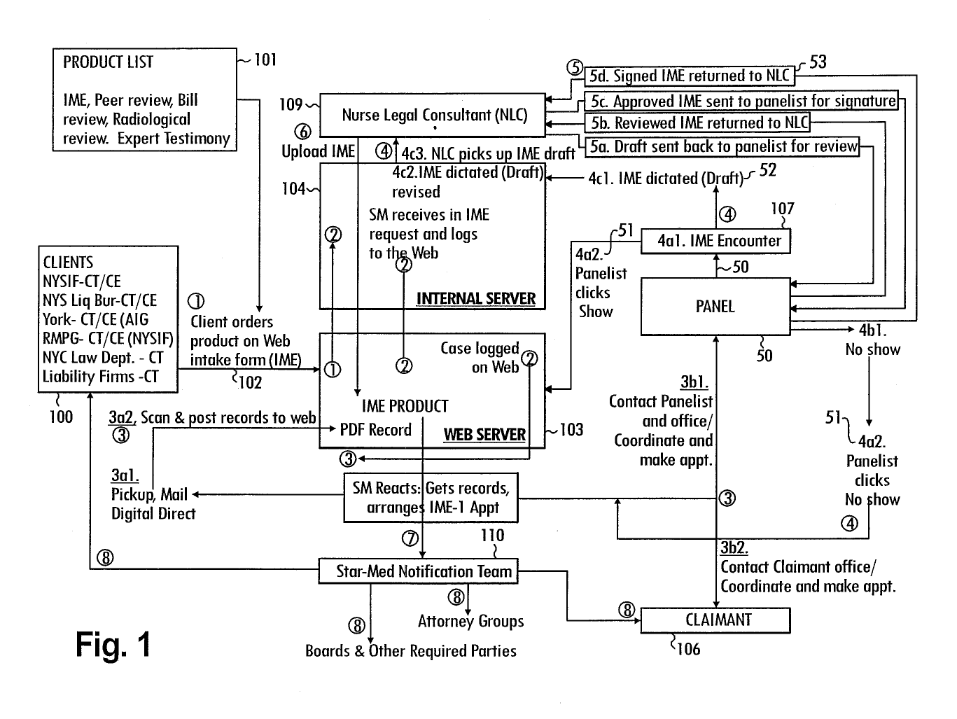

Referring now specifically to FIG. 1, and generally to respective and supportive images 2-13, a product ordering process is initiated by a client 100 signing onto the system employing a web log in to initiate a claim, reviews a claim product list 101, and selects or orders a product (such as an IME) on a web intake form along path 102 interfacing with a suitably programmed web server 103.

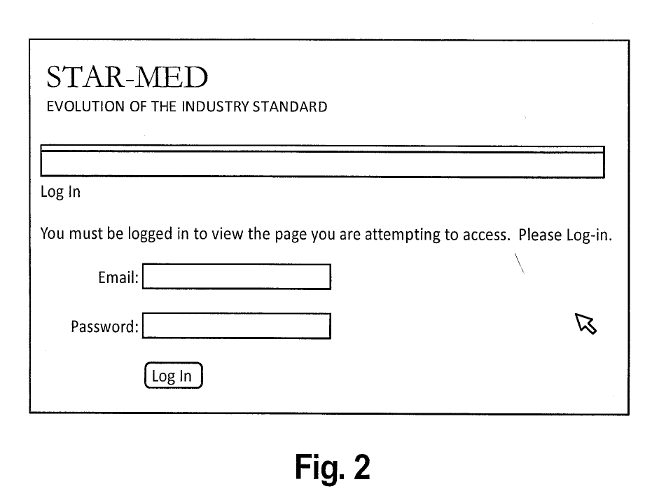

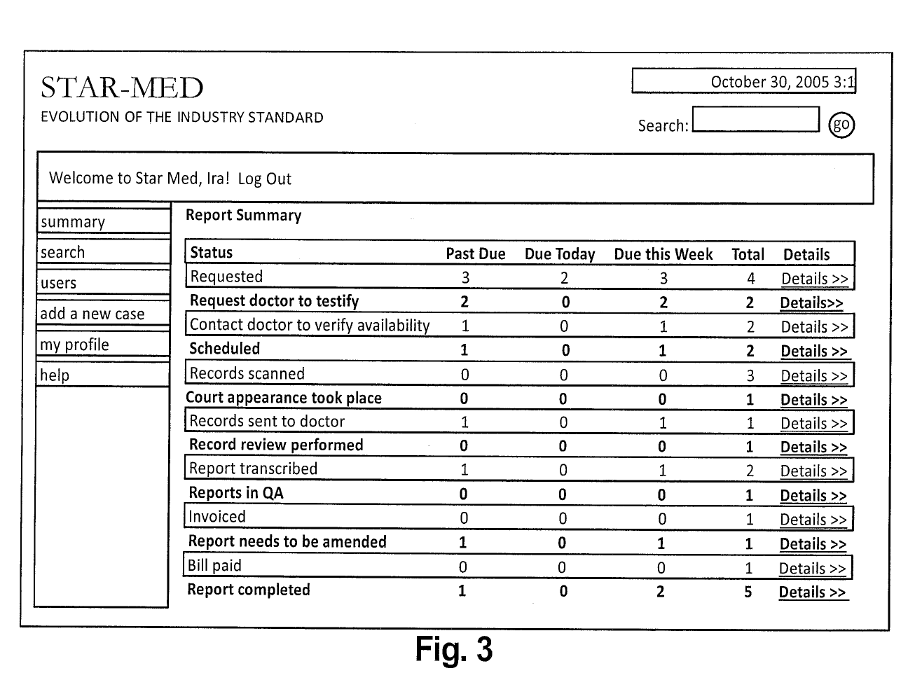

A specific client system log in image is shown at FIG. 2. The client may continuously view a status report summary as shown in FIG. 3. Such a report summary may include status, past due details, due today details, due this week details, and totals in each category, and a link to expand on various details of each product status. The report summary may include other categories related to the claim in question and the claim extends to an online single view summary screen including the specific topics mentioned and any other combinations of topics related to a topic view on a single reporting web screen.

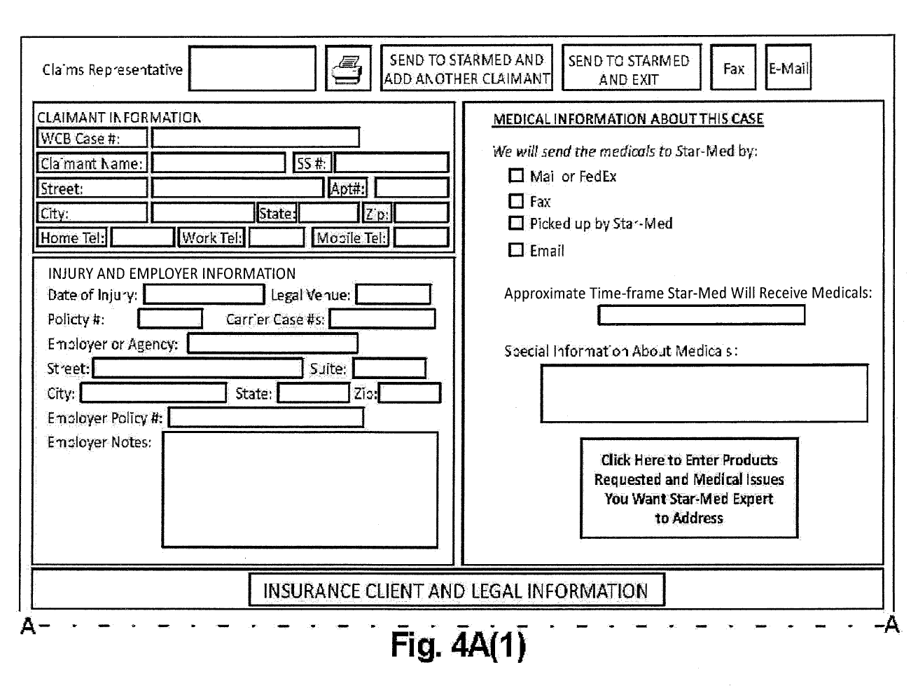

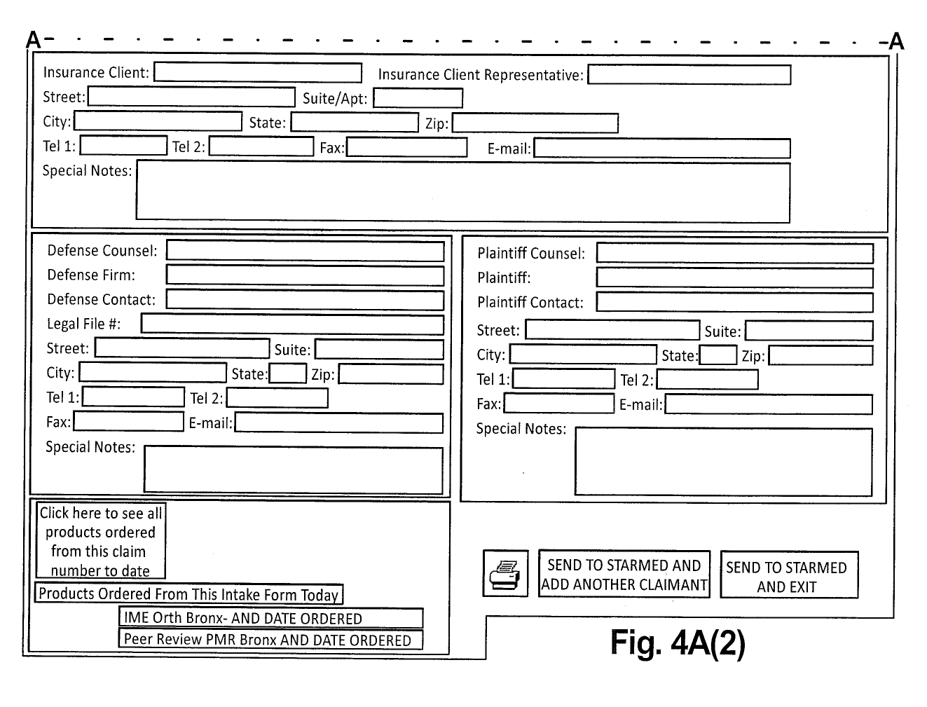

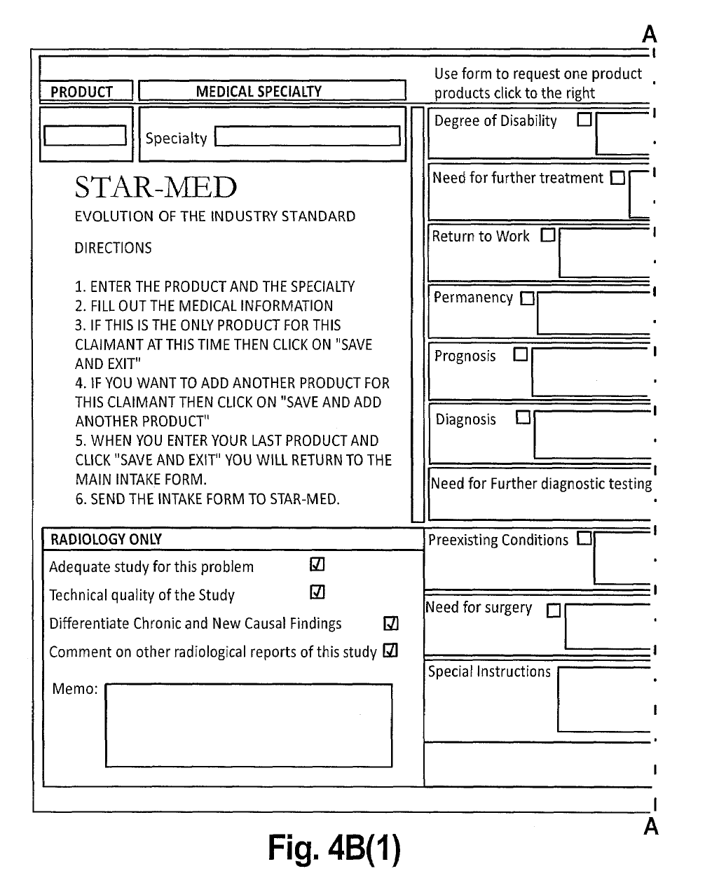

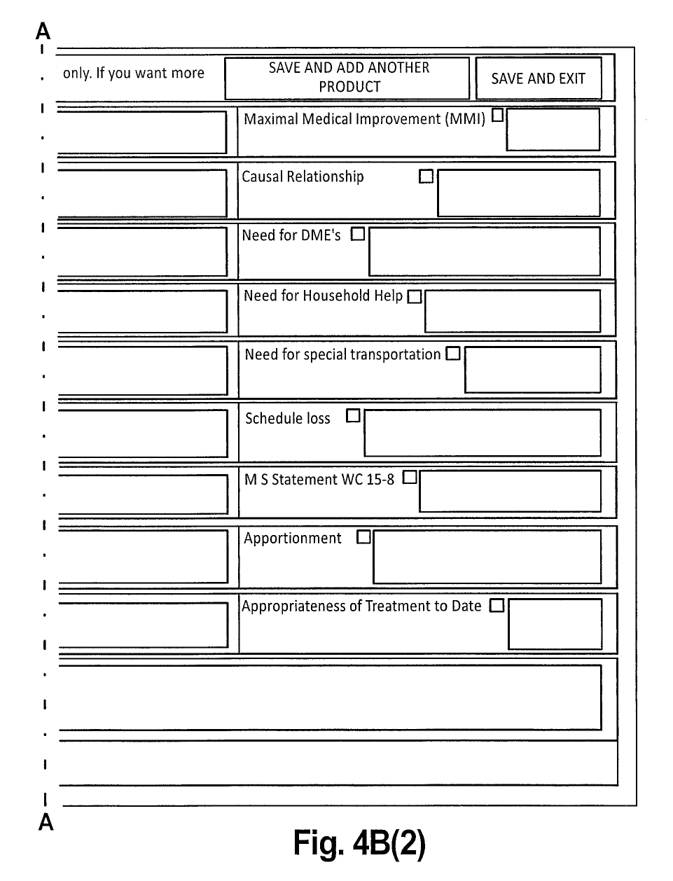

From the log on screen, the client 100 may navigate to a suitably selectable intake form with specific fields outlined in FIGS. 4A, 4B. This process also enables navigation to open up a separate and distinct “Request for Product and Medical Information Form” as an example of an IME linked product. The form envisioned allows for sending the completed form via email, via a web-enabled interface, printing, faxing, saving and exiting, saving and adding/editing another claimant, or product etc. and in ways understandable in the art.

The above inputs and selection process 1 enables the transmission to web server 103 of a “product”. Once a product is inputted in web server 103 it is internally transferred to an internal server 104 for administrative review.

During review at step points 2 a service manager (SM) such as an administrator receives automatic notification when an intake form is sent and allows the administrator/sm to check the accuracy of the log input on web server 103 and uploads this checked input onto the internal server 102 enabling later review by the panel, clients, and other required parties as will be discussed. Step 2 may be repeated as required for completion or may be augmented by nurse legal consultants (NLC).

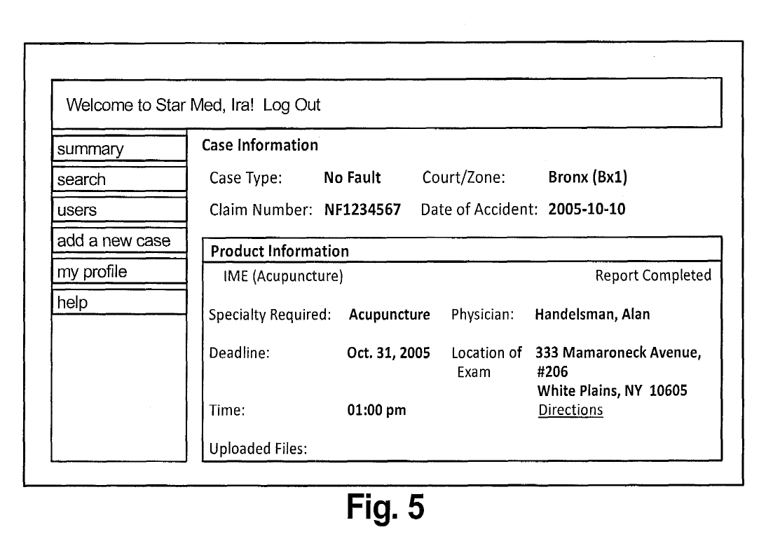

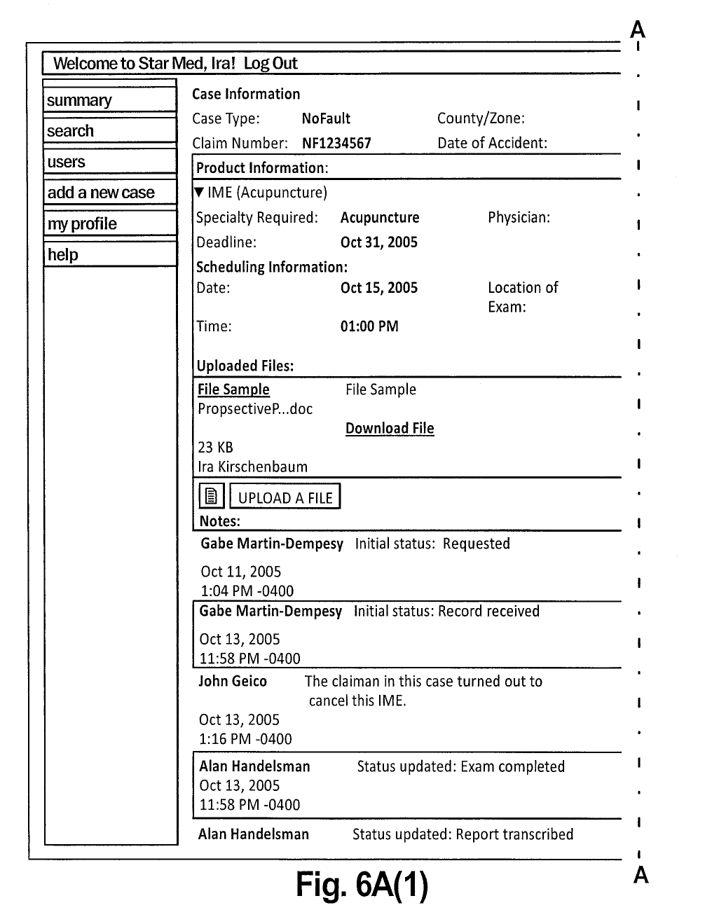

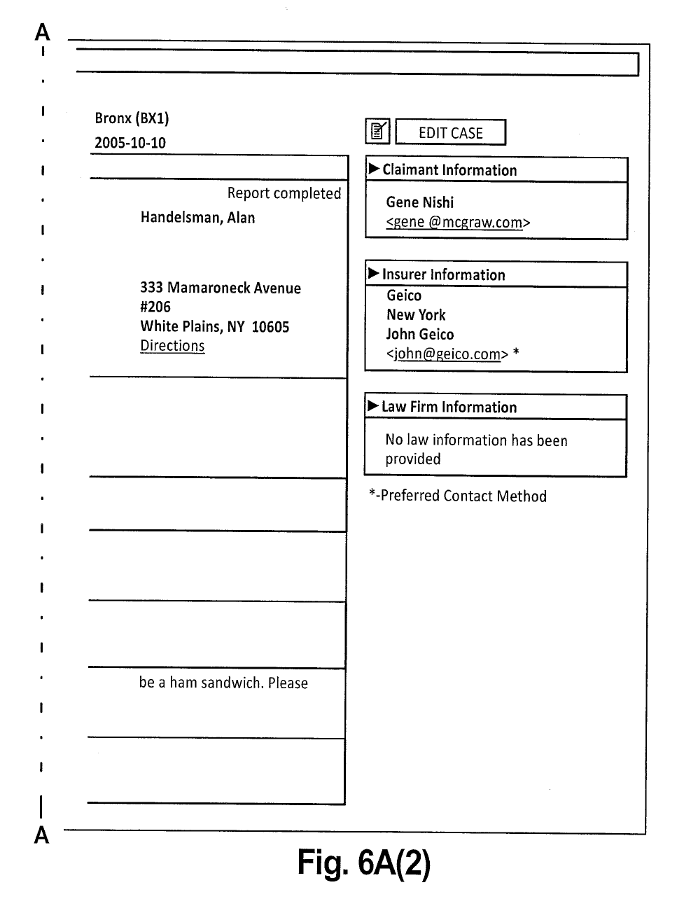

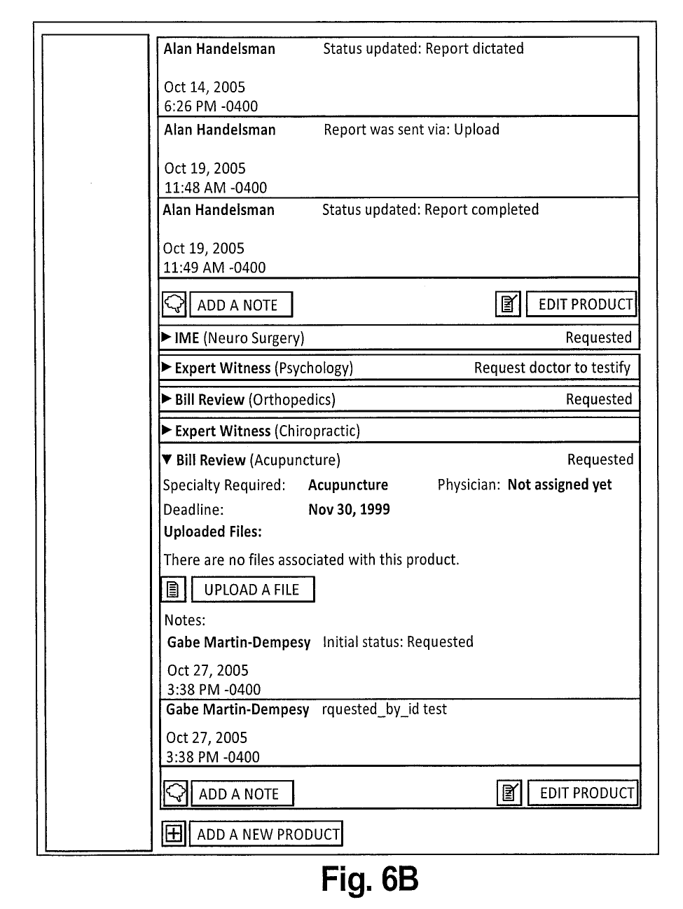

Following step 2, an administrator retrieves the medical records from client 100 and sorts the materials using book marking features and prepares a medical record in *.pdf (Adobe) format that is posted to web server 103 via steps 3a1 involving coordinating record pickups and step 3a2 wherein the completed report is posted to web server 103. The administrator then contacts the panel 105/panel members 105 via email and arranges for the appointment of a claimant 106 with panel 105. This appointment is then posted on the case information dialog box within web server 103. A portion of a case information dialog box is noted in FIG. 5 and is shown entirely in FIGS. 6A, 6B.

The features of the case information dialog box include:
A collapsed view of all products
An expanded view of all products that includes any or a combination of
   Scheduling information
   Panel
   Uploaded files
   Notes
   Claimant information
   Insurance information
   Law firm information
   Ability to upload a file
   Ability to add a note
   Ability to edit a product or select another
   Ability to add a new product

It should be noted that the ability to add or modify any of the above features is managed by a system administrator or client or nurse legal consultant, and the posting will be immediate of all information.

The completed “product” is then executed. The product for example may be an independent medical examination (IME) report. When the IME or any other Product is started panel 105 then begins a process called Bill-Check, indicated by steps 50, 51, 51, and 53, as noted in FIG. 1. There are four distinct check points that must be entered on the web data base that communicates specific information to the system administrator assigned. Upon completion of the fourth bill check point (step 53), this triggers an automated billing and check generation process to pay the panelist 105 for services rendered.

Specifically, step 50 represents when a panelist is shown an agreement related to a specific IME product. The IME agreement, which covers the points for the product, related to the panelists specific responsibilities concerning ethical, financial, and legal issues. When a panelist provides an indication of acceptance or “I agree” then billing checkpoint 50 is completed. Billing check point 50 may be completed before the IME is completed.

A Step 51 as noted occurs when a panelist provides via the web interface to server 103 a documentation of a claimant's show/no show status. This documentation indicates whether the patient appeared at an appointment, and as envisioned must be checked within 48 hours of a scheduled visit. As an inducement inherent in the system, failure to check a particular indication within a time period results in a reduction of fee for the panelist.

A step 52, as noted occurs when a panelist completes dictation of details of a completed IME examination. A step 53 occurs when a panelist authorizes completion of a final product (completed IME report), as shown.

As can bee viewed from FIG. 1, upon execution of the initial Product request a number of method steps 3 occur to enable generation of the end product. Steps 3 include step 3b1 wherein the system administrator contacts the panelist and or medical examining office to coordinate and schedule an appointment. Thereafter in a step 3b2 the administrator contacts claimant 106 to coordinate and schedule an appointment. Based upon these precursor steps an appointment is arranged.

Dependent upon scheduling an IME encounter 107 (step 4a1) occurs in generally in an extended step number 4. Following scheduling possible outcomes include a no-show step 4b1 where claimant 106 fails to show inducing an electronic indication of “no show” at step 4a2.

When panelist 105 clicks no-show, this begins an automated process wherein an administrator is notified of the no-show and reschedules claimant 106. When panelist 105 clicks show, this notifies the administrator that claimant 106 was seen and the product is dictated and manually or electronically sent to the administrator and uploaded to internal server 104. The process then calls for the administrator to assign a nurse legal consultant (NLC) 109 to retrieve the dictation and perform a quality assurance review (QAR) producing an initial draft at steps 4c2 and 4c3

When nurse legal consultant 109 finishes the quality assurance review process the result is sent through a product review process wherein the following process steps 5 are performed electronically through a web-enabled server or electronic mail. In a fist step 5a the initial draft is sent to panel 105 for review. In a second step 5b the reviewed and edited initial draft is returned via web server to nurse legal consultant 109 and in a third step 5c nurse legal consultant 109 prepares a final version draft and returns it to panel 105 for final review. In a fourth step 5d, panel 105 then applies an electronic signature, returns the completion via the web server to nurse legal consultant 109 and generates invoice completion step 53.

Thereafter nurse legal consultant 109 uploads the signed final version to web server 104 in a step 6 into the area of the case information dialog box for authorized viewing. From there the administrator is electronically notified of the upload of the final version and the administrator notifies in a step 7 notification team 110, which may include via further notification steps 8, client 100, required parties and boards, attorney groups, and claimant 106 allowable via secure authorized password to web server 103.

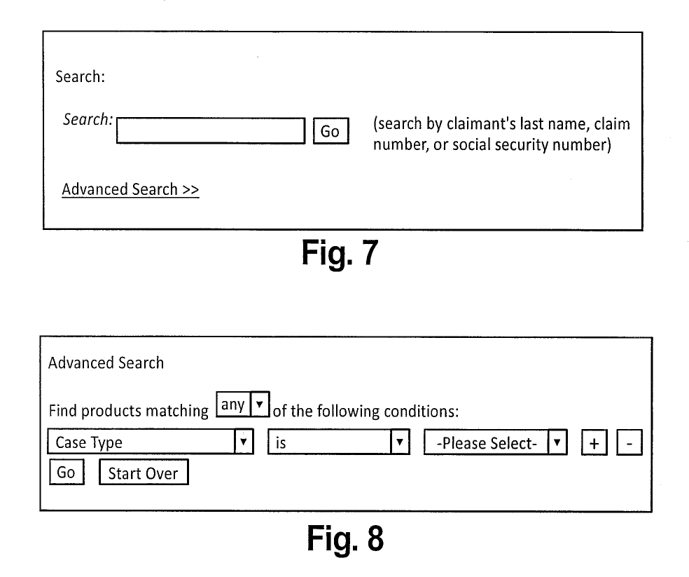

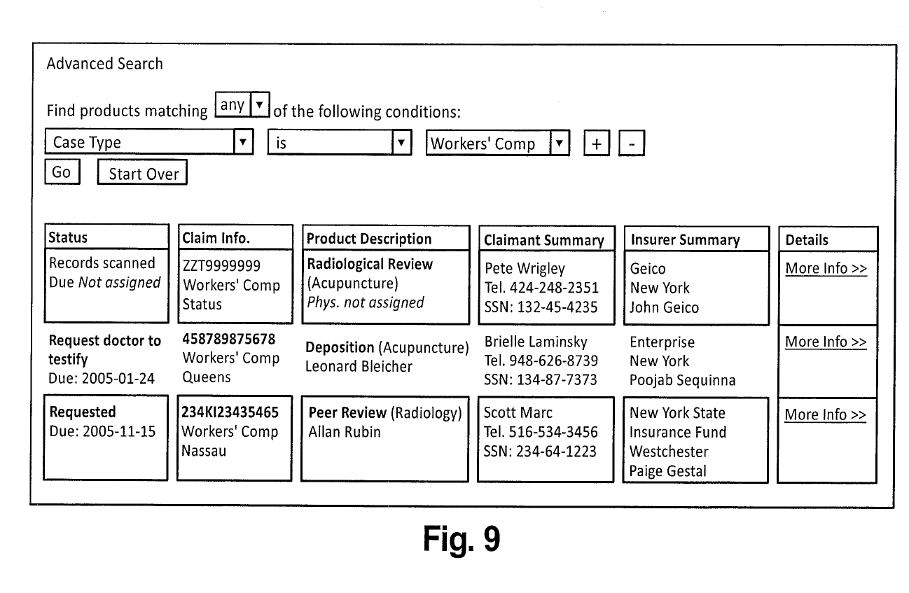

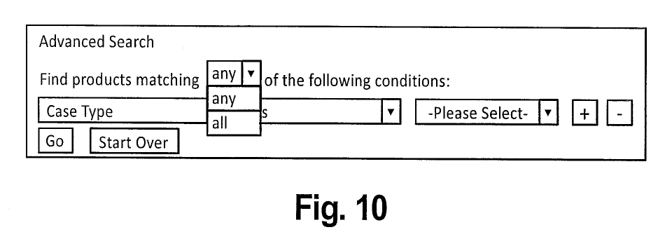

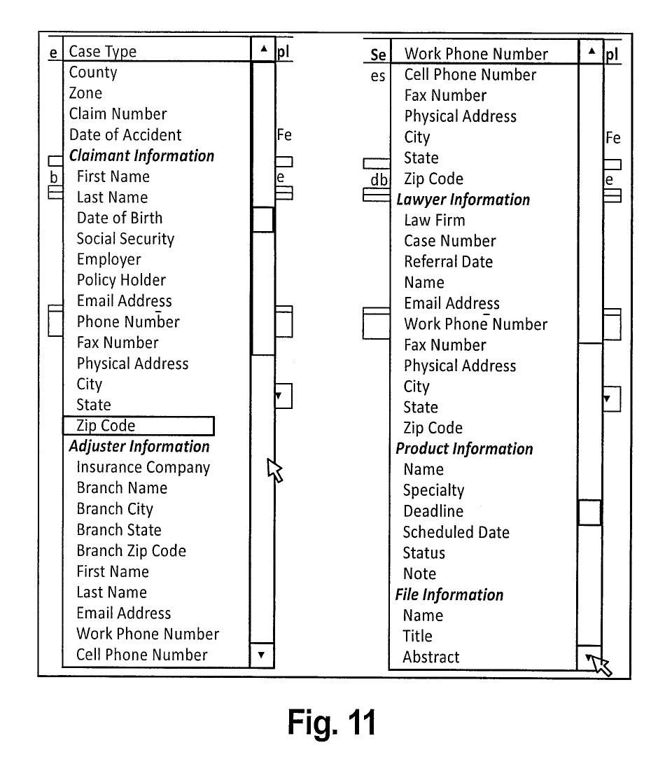

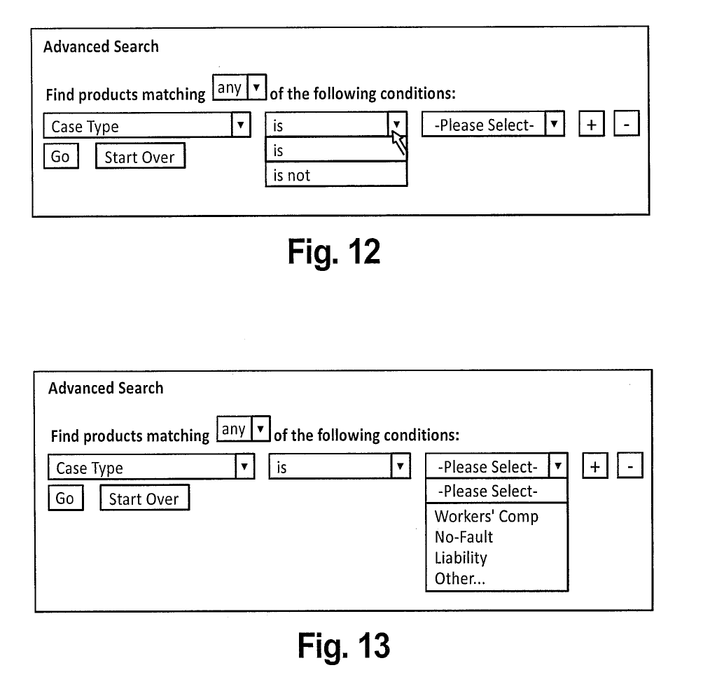

In a search and sorting process provided in the present system a basis search is provided (FIG. 7) and an advanced search is also provided (FIG. 8). The results of any search are in the specific format and information structure shown in FIG. 9. this includes any combination of status, claim information, product description, claimant summary, insurer summary, and other details. Additional details with this search and sorting process include:
Finding products that match “any” or “all” issues (FIG. 10).
Any combination of categories available (FIG. 11).
A settable condition of “is” or “is not” (FIG. 12).
A final parameter set by choice of a first category (FIG. 13).

As a point of further discussion, it will be recognized that the present system provides a features based security password algorithm having the capacity to distinguish Administrators and Clients. The Client category may include three levels of security for (a) Client administration passwords allowing viewing of all products within that client group, (b) client group passwords that are definable and can view all claims within a group of claim representatives, and (c) claims representative passwords that enable viewing of claims associated only with a single claim representative.

Similarly the present system envisions that a scheduling feature within internal server 104 and server 103 enables a schedulable (by day, time, month, etc.) dissemination of information via programmable modes including print, email, facsimile, and hand delivery or courier services.

It will be similarly noted that the present method envisions that panel 105/panelist 105 is assigned products either by direct request by panelist 105 or through a process termed IMEBay. Via the IMEBay process, product opportunities are posed on web server 103 in a manner viewable by panel 105 with or without notification. The administrator sets an acceptable bid value for the service requested (for example $100 for a medical review of an X-ray), referred to as a reserve price, and an active bidding process is conducted online for products (injury resolution related particularly), with the first bidder given the contract once the reserve price is met. If the reserve price is not met, the lowest bidder will win the contract and the information is automatically sent to the Administrator to start processing the product accordingly.

While several of the features of the instant system have been discussed in detail it will be noted that aspects of the present system readily enable a variety of resources; including (a) A panel of experts in a variety of fields, (b) the use of IME's and other customizable reviews representing a wide range of standard industry products and adapted versions of the same, (c) the availability of combination nurse legal consultants NLC to bring a new level to quality control to the process, (d) specialized digital radiology reviews by independent expert radiological review panelists separate from the IME that enhances the complete analysis of a case, (e) the employment of customized digital information management tools to manage the literal paper overflows of documents seen in the industry, (f) access to a simplified case compilation feature to provide a complete indexed digital book of an entire case, (g) customizable evidence-based medicine reports that support special legal, regulatory, and medical situations.

As discussed herein, the proposed system for enabling digital informational management enables (i) collating and organizing all IME's paper work by nurse legal consultant and presented on a password protected section in real time for all approved clients to review, (ii) employing a nurse-based or expert based system of quality assurance and panel training program to assure that that all questions are answered and as required documents digitally annotated, (iii) enabling the panel and clients to access the entire digital system through an encrypted website with multilevel security, (iv) providing a digital logistic system (as discussed herein) to speed the IME process, (v) allowing the proposed digital management system and quality panel to help the case managers on a daily basis, (vi) constructing rational web-meeting protocols to allow frequent access directly to the panel member reports in real-time, and (vii) operating with web-meeting software to allow clients to communicate with all authorized parties.

An additional benefit introduced above for the proposed digital imaging solution is that (1) all radiographic examinations are digitally scanned into a system that proprietary access software but open architecture image format (DICOM or JPEG), (2) all x-rays or images are transferable with the ability for the reviewer to annotate directly on the film, (3) x-rays and images are organized and categorized by the radiology nurse legal consultant to assure accuracy and proper flow, and finally (4) access to digital radiological examinations is through standard internet browsers (Internet Explorer or Netscape) for user convenience.

As noted above, the functions of a nurse legal consultant (NLC) is various and involves; receiving information from a variety of sources and fully analyzing such materials for accuracy and voids, cataloging such material using a Tree-based Hierarchy System fully digitized using an open access compression format that is viewable through multi-level security access passwords, identifying evolving standards of care, causation and damage issues, providing initial case screenings for merit, conducing client interviews when necessary, preparing chronologies of medical events, developing digital document management e-Books for better system management, educating clients, attorneys and panel members regarding medical facts and issues relevant to case, assisting with (as necessary) depositions and trials, developing compilation summaries, manage panel members relative to client telephone, web-based, or pre-trial meetings, and finally locating and procuring medical and factual evidence.

As used herein, the phrase secure-access, or secure database, or secure computer will be understood by those of skill in the art as representing an electronic database support platform (personal computer based, intra-net based, inter-net based, wireless, or personal digital assistance) that requires a secure entry process for operation (for example, the use of a user name and password, or biometrics, or other secure encodation and access modalities known in the fields of computer security).

Those of skill in the art will recognize that the phrase panelist, medical examiner, qualified examination panelist, etc. shall be recognized as broadly representing an individual or groups of individuals who are both professionally qualified to conduct a medical examination (for example, Medical (MD) Professionals, Osteopathic (OD) Professionals, Chiropractors, Radiologists, Surgically Trained professionals, Physical therapy trained professional, Psychiatrists, Registered Nurses, Psychologists, Physical and mental rehabilitation professionals and others practicing within the fields treating an individual's physical and mental health) and who are selected to participate in the use of the proposed system.

As used herein the phrase independent medical examination agreement shall be understood broadly to represent the contracting information provided to a qualified examination panelist to review (such as claimant details, medical details, request details) and if acceptable to form agreement with such as bind the panelist in contract to generate the IME report following the process system steps discussed herein.

As used herein, the phase independent medical report product shall be interpreted broadly to include not only the independent medical examination (IME) report itself, but also all related supporting documents to the generated IME; including radiological and chemical tests, radiological images, emails, panel members who reviewed the IME, lists of participants an IME review and their respective comments regarding the IME report, notification team requirements for report delivery, panelist or IME review invoices and billing matters, scheduling maters and much more. As a consequence it shall be understood that the present system herein encompasses a broad range of products each related to the IME but not required to be the IME report itself.

As used herein, the phrase documentation or documentation by a panelist, or a documentation of the transmission of a timed report to a member of the notification team shall be interpreted broadly to include both an electronic data entry, a physical data entry on a form, or an input entered into a computer system or via the intranet within a grouping of computers or via the internet within a group of linked computers. Thus, for example a panelist may document an invoice entry via the submission of an email while also document an entry of an independent medical examination report via the act of submitting the same to a computer system linked with a server.

As used herein the phrase notification team shall be interpreted broadly to include all those who interconnect with or receive reports of any kind from the proposed system. The notification team members may be government agencies and offices, legal offices, medical offices, management members, selected claimants, panelists, and others within the chain of communication as discussed herein.

As similarly discussed herein, the preferred method and system discusses a team-work between a panelist member generating data for review by a nurse consultant but this shall not be limiting of the discussion herein, as those of skill in the art will recognize that in particular circumstances, for example, a panelist may generate and review their completed IME report and submit the same to a central management server without assistance.

As discussed herein an authorized delivery pathway for delivering an independent medical examination (IME) report shall be broadly determined and shall include without limitation delivery by hand, by regular postal and courier services, electronic delivery via email, facsimile, and by entry into a secure database accessible by an authorized recipient and in other ways and manners known in the arts of item delivery.

In the claims, means- or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. A method, for managing an invoice generation system for use during an independent medical examination (IME), the method comprising the steps of:
providing a secure-access electronic computer system for managing the generation of an independent medical examination report product and said invoice;
enabling at least one qualified examination panelist to access said secure-access electronic computer system;
providing at least one prepared independent medical examination agreement for acceptance by said qualified examination panelist;
initiating a first electronic panelist invoice check point upon an acceptance of said independent medical examination agreement thereby engaging said panelist to conduct said independent medical examination report and opening said invoice generation system for tracking said independent medical examination;
initiating a second electronic panelist invoice check point in said invoice tracking system upon a documentation by said panelist as to whether or not a patient appeared at a scheduled time for said examination and completed of such examination;
initiating a third electronic panelist invoice check point in said invoice tracking system upon a completion of an initial data entry of a result of said examination; and
initiating a fourth electronic panelist invoice check point in said invoice tracking system upon a final authorization by said panelist of a completed said independent medical examination report product incorporating said initial data entry, whereby said method enables a generation of an invoice for said panelist and a payment of said panelist.

2. A method, according to claim 1, wherein said step of initiating said second electronic panelist invoice check point further includes the step of:
determining at least a first deduction of a fee paid to said panelist upon at least a first timed delay of said panelist to complete said step of initiating a

3. A method, according to claim 1, wherein:
said step of providing a secure-access electronic computer system further comprises the step of:
providing an internet access to said electronic computer system, whereby said method enables a convenient use.

4. A system, for generating an independent medical examination (IME) report product, the system comprising:
electronic means for generating a request from a first party for an independent medical examination of a claimant by at least one panelist from a plurality of available panelists;
means for selecting and engaging said at least one panelist to conduct said independent medical examination;
invoice tracking means for tracking a scheduling and an examination activity of said at least one panelist relative to a process schedule of said independent medical examination;
electronic means for recording a completed independent medical examination report product in a secure authorized user accessible computer system upon a completion of said independent medical examination report product; and
means for scheduling a sequenced delivery of at least one designated element in said independent medical examination report to at least one of a plurality of notification team members along an authorized pathway, whereby said system enables a secure recordation and delivery of an independent medical examination report in a reliable and effective manner.

5. A system, according to claim 4, wherein:
said first party is at least one of a group comprising, a claimant, an insured individual, an insurance agent, a legal party, a panelist, and a notification team member.

6. A system, according to claim 4, wherein:
said means for scheduling a sequenced delivery of at least one designated element further comprises:
means for recording both delivery mode preference and a delivery schedule requirement of said at least one notification team member; and
means for transmitting said independent medical examination report by said delivery mode preference at said delivery schedule requirement to said at least one notification team member, whereby said system enables a reliable delivery of said report at a reduced report loss rate.

8. A system, according to claim 4, further comprising:
computer tracking means for receiving and recording said request from said first party for said independent medical examination of said claimant;
computer management and data base means for enabling said system to be securely accessed via the world-wide web and for information retained thereon to be accessible by an authorized user.

9. A system, according to claim 4, further comprising:
independent review means in said electronic means for recording a completed independent medical examination report; and
said independent review means comprising:
at least one means for generating an independent review of said completed independent medical examination by least one additional panelist from said plurality of available panelists that is different from said one panelist, whereby said system enables said independent review as a quality control measure.

10. A system, for enabling an auditable secure independent medical examination (IME) report, the system comprising:
an electronic system for originating and tracking a development of said independent medical examination (IME) report; said electronic system comprising:
secure electronic database means for enabling a secure entry by a plurality of authorized users of a plurality of tracking steps employed by said system for recording and storing execution data of respective said plurality of tracking steps and entry data of respective said plurality of users;
electronic means for generating a request from a first party for an independent medical examination of a claimant by at least one panelist from a plurality of available panelists;
said electronic means including means for securely entering a record of said generation of said request in said secure electronic database means;
means for selecting and engaging said at least one panelist to conduct said independent medical examination;
said means for selecting and engaging including means for securely entering a record of said selecting and engaging in said secure electronic database means;
electronic means for recording a completed independent medical examination report product in said secure authorized user accessible database upon a completion of said independent medical examination report product; and
report means for generating an auditable report of each entry of respective said records, each said authorized user access of said respective said records, and said independent medical examination (IME) report in said secure database, whereby an external review of said system and said database enables a determination of changes to said database via an audit report.

11. A system, according to claim 10, for enabling an auditable secure independent medical examination (IME) report, the system further comprising:
invoice tracking means for tracking a scheduling and an examination activity of said at least one panelist relative to a process schedule of said independent medical examination; and
said invoice tracking means for tracking including means for securely entering a record of said scheduling and said examination activity in said secure electronic database means, thereby enabling an auditable record of said examination activity.

12. A system, according to claim 10, for enabling an auditable secure independent medical examination (IME) report, the system further comprising:
means for scheduling a sequenced delivery of at least one designated element in said independent medical examination report to at least one of a plurality of notification team members along an authorized delivery pathway, whereby said system enables a secure recordation and delivery of an independent medical examination report in a reliable and effective manner; and
said means for scheduling a sequenced delivery including means for securely entering a record of said sequenced delivery in said secured electronic database, thereby enabling an auditable record of said sequenced delivery.

13. A system, for enabling a timed distribution of an independent medical examination (IME) report, the system comprising:
means for generating a secure access database for receiving and storing said generated independent medical examination (IME) report;
database means for receiving and storing an inputted sequenced delivery preference of at least one designated element in said independent medical examination (IME) report to at least one of a plurality of notification team members along at least one of a plurality of authorized delivery pathway;
means for scheduling a delivery of said designated element in said independent medical examination (IME) report according to said inputted preferred sequenced delivery; and
means for delivering said designated element via said authorized delivery pathway, whereby said system enables said timed distribution of said at least one element to said at least one notification team member in a reliable and predetermined manner.

14. A system, according to claim 13, for enabling a timed distribution of an independent medical examination (IME) report, further comprising:
a plurality of inputted sequenced delivery preferences of respective said designated elements matched with a respective plurality of authorized delivery pathways.

15. A system, according to claim 14, for enabling a timed distribution of an independent medical examination (IME) report, wherein:
at least two of said respective inputted sequenced delivery preferences being on differing days; and
at least two of said respect authorized delivery pathways being different, whereby said means for delivering enables said timed distribution in a reliable manner despite preference and pathway differences.

16. A management method managing the generation and transmission of an independent medical examination with a generating system, the method comprising the steps of:
initiating an authorized entry of said generation system via a web-enabled interface;
entering a plurality of information effective to complete a web-enabled request initiation form for generating a request of said independent medical examination by a claimant;
generating a request summary report for requesting said independent medical examination;
automatically notifying said generating system upon a user-completion of said web-enabled request initiation form;
employing a book marking system for preparing a medical request summary and for posting of the same on said generating system;
arranging for an appointment of said claimant with at least one of a plurality of panel members and for posting said appointment on said system;
conducting, by said at least one panel member, of an independent medical examination;
returning a completed independent medical examination report to selected ones of said panel members for a quality assurance review of the same; and
uploading a quality-assurance-completed independent medical examination report to said system for distribution of the same.
